(19) United States
(12) Patent Application Publication
(10) Pub. No.: US 2021/0392269 A1
(43) Pub. Date: Dec. 16, 2021

(54) MOTION SENSOR IN MEMORY

(71) Applicant: Micron Technology, Inc., Boise, ID (US)

(72) Inventors: Zahra Hosseinimakarem, Boise, ID (US); Debra M. Bell, Boise, ID (US); Cheryl M. O'Donnell, Boise, ID (US); Roya Baghi, Boise, ID (US); Erica M. Gove, Boise, ID (US)

(21) Appl. No.: 16/900,330

(22) Filed: Jun. 12, 2020

(51) Int. Cl. H04N 5/232; G01C 19/5712

(52) U.S. Cl. CPC H04N 5/23258; B60T 7/12; G01C 19/5712

(57) ABSTRACT

Systems, apparatuses, and methods related to memory device sensors are described. Memory systems can include multiple types of memory devices including memory media and can write data to the memory media. Some types of memory devices include sensors embedded in the circuitry of the memory device that can generate data. The memory device can transmit the data generated by the embedded sensor using a sensor output coupled to another device. In an example, a method can include generating orientation data, including coordinates, of a memory device by measuring linear acceleration or rotational motion using a motion sensor embedded in circuitry of the memory device, receiving a signal that represents image data from an image sensor, and pairing the orientation data of the memory device with the image data.

### TECHNICAL FIELD

The present disclosure relates generally to semiconductor memory and methods, and more particularly, to apparatuses and methods related to a motion sensor in memory.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices can be coupled to another device (e.g., a computing device, a processing resource, etc.) to store data, commands, and/or instructions for use by the device while the computer or electronic system is operating. For example, data, commands, and/or instructions can be transferred between the other device, an image sensor, and/or the memory device(s) during operation of a computing or other electronic system.

### BRIEF DESCRIPTION OF THE DRAWINGS

FIG. 1 is a functional block diagram of an apparatus in the form of a computing system including memory device sensors in accordance with a number of embodiments of the present disclosure.

FIG. 2 is a functional block diagram in the form of a computing system including device sensors in accordance with a number of embodiments of the present disclosure.

FIG. 3 is a block diagram of a sequence of image data and orientation data in accordance with a number of embodiments of the present disclosure.

FIG. 4 is a flow diagram representing an example method for memory device sensors in accordance with a number of embodiments of the present disclosure.

### DETAILED DESCRIPTION

Systems, apparatuses, and methods related to using memory device sensors are described. Some memory systems or device types include sensors embedded in their circuitry. Another device can be coupled to a memory device with an embedded sensor. The memory device can transmit the data generated by the embedded sensor using a sensor output coupled to the other device. The memory device may generate orientation data, including coordinates, of the memory device by measuring linear acceleration and/or rotational motion using a motion sensor embedded in circuitry of the memory device, receive a signal that represents image data from an image sensor, and pair the orientation data of the memory device with the image data.

Utilizing sensors embedded in memory devices to obtain information generated by the embedded sensor can conserve resources (e.g., space, money, power, etc.) by removing the need to include hardware for an external sensor. For instance, another device can be coupled to a memory device including an embedded sensor. The memory device can transmit the signal generated by the embedded sensor using a dedicated sensor output coupled to the other device. In a number of embodiments, a memory system can include an image sensor coupled to the memory device and/or the other device.

A computing system including memory devices can include one or more different memory media types which can be used to store (e.g., write) data in a computing system. Such data can be transferred between the computing system and the memory system. The data stored in the memory media of the memory device can be important or even critical to operation of the computing system and/or another device connected to the memory device. There are various types of memory devices including memory media. Some examples of memory media include, non-volatile memory and volatile memory.

Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory (e.g., 3D XPoint™), resistive random access memory (RRAM), ferroelectric random access memory (FeRAM), magnetoresistive random access memory (MRAM), and programmable conductive memory, among other types of memory. Volatile memory can require power to maintain its data (e.g., error data, etc.) and includes random-access memory (RAM), dynamic random access memory (DRAM), and static random access memory (SRAM), among others. Some types of memory devices can include sensors embedded in the circuitry of the memory device.

For example, DRAM can include one or more sensors (e.g., a temperature sensor) that are embedded in circuitry. The embedded sensors can be programmable to generate a signal. The signal can represent sensor data and the memory device (e.g., including DRAM) can receive the signals and store the data associated with the sensors (e.g., sensor data). The signal can represent data related to an environment where the DRAM is located and/or related to another device that is coupled to the DRAM. Computing devices can frequently include DRAM as memory media. As other devices such as, wireless communication devices, mobile devices, semi-autonomous vehicles, fully autonomous vehicles, Internet of Things (IoT) devices, mobile artificial intelligence systems, etc. become more prevalent, sensors and other devices related to computing systems are also increasingly needed to generate information about the surroundings of the computing device. As such, there is a growing need for information gathered by sensors coupled to computing devices.

In some approaches, external sensors can be coupled to a host and transmit a signal including sensor data to a memory device coupled to another device that can be included in a host. This approach can provide a signal generated from the sensor to the host. This approach can be slow, costly, and the sensors can occupy space that may not be readily available, consume excess power, and/or otherwise waste resources of the computing system (e.g., host).

Hosts can include processors, a central processing unit (CPU), and/or be another device connected to the memory device. Such hosts include edge computing devices, computing devices within a mobile device, computing devices within vehicles (e.g., autonomous or semi-autonomous vehicles, unmanned aerial vehicle (UAV), etc.) and can use memory devices such as DRAM to execute applications and may benefit from the use of sensors. In some examples herein, memory devices including memory media such as DRAM may include sensors on-board (e.g., embedded in circuitry of the memory device). For example, a vehicle can include a device (e.g., a computing device, a processor, a CPU, etc.) to execute instructions stored in a memory device coupled to the device within the vehicle. The sensors may be intermittently or consistently generating signals including sensor data to be written (e.g., stored) in the DRAM, however, end application access to the sensor data stored in DRAM is not always possible or efficient. As more devices (e.g., edge computing devices, vehicles, etc.) utilize DRAM, and storage capability of memory systems increase, the volume of sensor data generated by embedded sensors increases, and the effects of the inability to access sensor data stored in DRAM become more pronounced. These effects can be further exacerbated by the limitations of some approaches to read and interpret sensor data from external sensors such that the contents can be effective, especially as the amount of sensor data stored in memory systems and the speed at which sensor data retrieval is expected.

In contrast, embodiments herein are directed to enabling end application, user applications, and/or host applications, access to sensors embedded in memory devices such that the devices coupled to the memory device can conserve resources by refraining from the installation of external sensors thus saving power, unnecessary hardware, cost, etc. Hosts can take advantage of already existing embedded sensors included in memory devices coupled to the host. For example, in a context of mobile devices and/or partially or fully autonomous vehicles, decisions related to signals received from sensors may require end-user access such that actions can be taken quickly, efficiently, or otherwise interpreted. Enabling the use of sensors already existing on DRAM can increase the availability of such sensor data from sensors.

In another embodiment, sensors described herein can be located and/or exist near and/or on a scribe line in semiconductor memory devices. A scribe line can be located on a semiconductor wafer between dies such that the dies can be separated. In some examples, sensors are integrated on a semiconductor wafer near and/or on the scribe line during manufacturing. Enabling the use of these integrated (e.g., embedded) sensors post-manufacturing can increase the availability of data collected by the sensor without the need of extra and/or external hardware.

Embodiments herein describe another device coupled to a memory device that can be configured by a controller e.g., a processor, control circuitry, hardware, firmware, and/or software and a number of memory devices each including control circuitry. The controller can include a command decoder to output a value to another device included on the host. As used herein, the term “value” refers to an output from a sensor embedded in a memory device. Some examples of values can include a temperature value e.g., a temperature in Fahrenheit, Celsius, Kelvin, or any other unit used to measure thermodynamic temperature. The temperature value can be transmitted as an encoded 8-bit binary string. Another example of a value can be a unit of time (e.g., microseconds (μs), seconds, minutes, etc.), or a quantity of detection events. A detection event can be a quantity of motion events detected by a motion sensor embedded in a memory device and a motion value and/or a motion sensor value can be a quantity of motion events detected. In a number of embodiments, a value can be a coordinate. For example, an orientation of a memory device can be generated by a motion sensor, expressed as degree values, and transmitted to another device.

The output can be transmitted from the memory device using a sensor output. As used herein, the term “sensor output” refers to an output component that is configured to transfer sensor data (e.g., a value) from an embedded sensor to another device and/or a host. For example, a sensor output can be separate from a data output generally included on a bus. The sensor output can be used to transmit an indication about the signal that represents sensor data to another device and/or the host. The sensor output can be dedicated to the sensor such that it is configured to transmit the signal that represents sensor data and/or an indication to the other device.

In some examples, a sensor output described herein can be a value generated as an average of more than one embedded sensor. In some examples, the sensor output can be a weighted average of more than one embedded sensor where the weight is based on the location of the embedded sensor relative to the area where the sensor is generating a signal that represents sensor data. For example, more than one embedded temperature sensor can be located in various positions on a host to monitor the temperature of the interior of the host. The temperature value generated by an embedded sensor located nearest to the interior sensor can be weighted higher than a different embedded sensor generating a signal representing temperature data from farther away from the interior of the host.

In another embodiment described herein, memory devices including memory media such as DRAM having an embedded sensor can be configured to transmit a signal that represents sensor data from the embedded sensor to another device coupled to the memory device using standard I/O lines included in a bus. For example, a controller (e.g., a command decoder) can receive a command (e.g., a multi-purpose register read command), and the memory device can be configured to map each embedded sensor output to a corresponding multi-purpose register. In this example, existing bandwidth of the memory device can be used to conserve the need for a dedicated sensor output.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

As used herein, designators such as “N,” “M”, “P”, etc., particularly with respect to reference numerals in the drawings, indicate that a number of the particular feature so designated can be included. It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context, and, unless stated otherwise, can include a wireless connection. The terms “data” and “data values” are used interchangeably herein and can have the same meaning, as appropriate to the context.

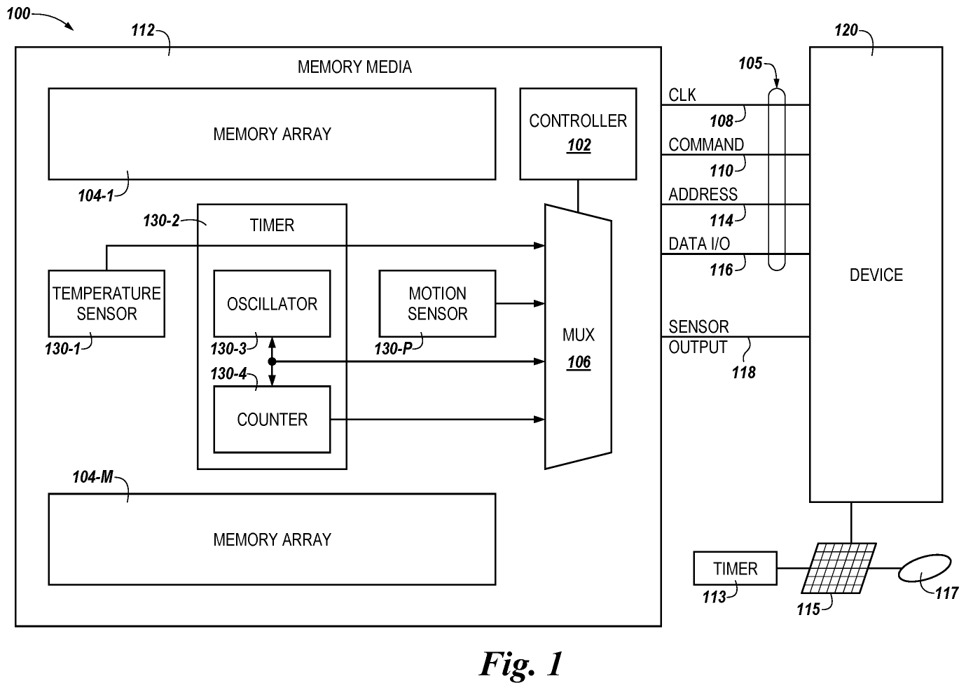

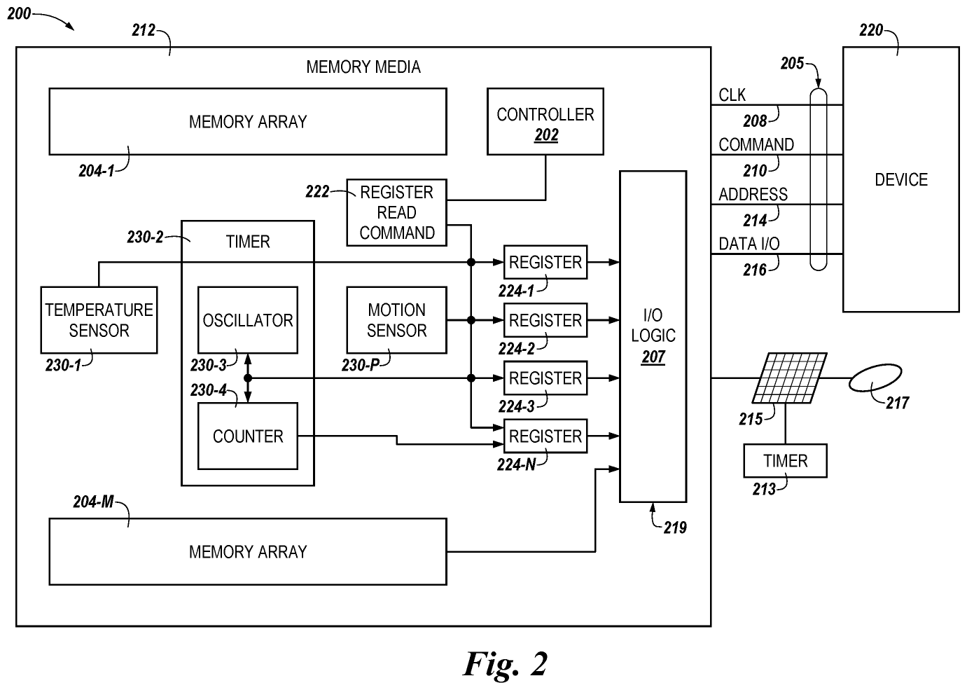

The figures herein follow a numbering convention in which the first digit or digits correspond to the figure number and the remaining digits identify an element or component in the figure. Similar elements or components between different figures can be identified by the use of similar digits. For example, 106 can reference element “06” in FIG. 1, and a similar element can be referenced as 206 in FIG. 2. A group or plurality of similar elements or components can generally be referred to herein with a single element number. For example, a plurality of reference elements 230-1, . . . 230-P (e.g., 230-1 to 230-P) can be referred to generally as 230. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram of an apparatus in the form of a computing system 100 including memory device sensors in accordance with a number of embodiments of the present disclosure. As used herein, an “apparatus” can refer to, but is not limited to, any of a variety of structures or combinations of structures, such as a circuit or circuitry, a die or dice, a module or modules, another device or devices, or a system or systems, for example. The computing system 100 can include memory device 112. The memory device 112 can include memory array 104-1 and memory array 104-M which may be collectively referred to herein as the memory array 104. The memory device 112 can include a controller 102 coupled to a multiplexer (MUX) 106. The MUX 106 can be coupled to one or more sensors embedded in circuitry of the memory device 112. For example, the MUX 106 can be coupled to a temperature sensor 130-1, a timer 130-2 (e.g., for self-refresh control), an oscillator 130-3, a counter 130-4, and/or a motion sensor 130-P, which may be collectively referred to as the sensor or the sensors 130. A motion sensor 130-P can include integrated orientation sensors such as accelerometers and/or gyroscopes (e.g., microelectromechanical system (MEMS) gyroscope). The motion sensor 130-P can generate orientation data of the memory device 112 by measuring linear acceleration and/or by measuring rotational motion of the memory device 112. In some examples, the orientation data can include orientation identifiers and/or a timestamp (e.g., a time at which the orientation data was generated) generated by timer 130-2. Although specific types of sensors are mentioned herein, embodiments are not so limited and other sensors can be used (e.g., a pressure sensor and/or a random number generator).

The memory device 112 can include volatile or non-volatile memory. For example, the memory media of the memory device 112 can be volatile memory media such as DRAM. DRAM can include a plurality of sensors which can be at least one of a temperature sensor, a motion sensor, an oscillator, a timer, or a combination thereof. The memory device 112 can be coupled to another device 120 via a bus 105. The bus 105 can include a clock line (CLK) 108, a command line 110 to transmit commands, an address line 114 to determine where commands should be sent, and a data input/output (data I/O) 116. The other device 120 can be a CPU, a graphics processing unit (GPU), an application specific integrated circuit (ASIC), an edge computing device, etc. The device 120 can be a host (e.g., a processor) and/or included as part of a host (e.g., a computing device within another device).

For example, a host can be a host system (e.g., a computing system within a larger device) such as a computing device within a wireless connected device, a computing device within a personal laptop computer, a computing device within a vehicle, a CPU and/or processor within a desktop computer, a computing device within a digital camera, a computing device within a mobile telephone, an internet-of-things (IoT) enabled device, or a computing device within a memory card reader, a computing device within graphics processing unit (e.g., a video card), among various other types of hosts. As used herein an “IoT enabled device” can refer to devices embedded with electronics, software, sensors, actuators, and/or network connectivity which enable such devices to connect to a network and/or exchange data. Examples of IoT enabled devices include mobile phones, smart phones, tablets, phablets, computing devices, implantable devices, vehicles, home appliances, smart home devices, monitoring devices, wearable devices, devices enabling intelligent shopping systems, among other cyber-physical systems.

The host and/or the other device 120 can include a system motherboard and/or backplane and can include a number of memory access devices, e.g., a number of processing resources (e.g., one or more processors, microprocessors, or some other type of controlling circuitry). One of ordinary skill in the art will appreciate that “a processor” can intend one or more processors, such as a parallel processing system, a number of coprocessors, etc. The device 120 can be coupled to memory device 112 by the bus 105.

The controller 102 can include a command decoder which can receive commands from the command line 110 of the bus 105. The command to read data from a sensor 130 can be received by the controller 102. The command can be a mode register type command from the other device 120 which can include information related to which sensor needs to output a signal representing sensor data using the sensor output 118. The MUX can be a device that selects between analog and digital input signals received from selection pins and forward the signal to the sensor output 118.

As mentioned, the computing system 100 includes a sensor 130 embedded in circuitry the memory device 112. The sensor 130 can be configured to collect data related to the other device 120 connected to the memory device 112. For example, the other device 120 can be a part of and/or coupled to a host. The sensor 130 can be embedded in the memory device 112 such as including memory such as DRAM and collect data corresponding to an orientation of the other device 120. Said differently, the embedded sensor 130 can be a motion sensor 130-P which can generate a signal representing motion sensor data (e.g., a particular coordinate value) in the form of degrees of the host and/or an orientation of the host.

The memory device 112 can be configured to transmit the sensor 130 signal that represents sensor data to the other device 120 using the sensor output 118. For example, the sensor output 118 coupled can be coupled to one or more of the sensors 130 and to the other device 120 to transmit the signal that represents sensor data collected by the sensor 130 to the other device 120. The sensor output can be dedicated to the sensor embedded in the memory device 112. In this way, embedded sensors 130 can be accessible by end applications (e.g., users, hosts, etc.) to provide sensor generated data.

In some embodiments, the MUX 106 can receive signals that represent sensor data from multiple sensors 130 responsive to receiving a command from the controller 106. For example, the controller 106 can receive a request from the other device 120 via the bus 105 to read sensor data from one or more sensors 130. Responsive to receiving the request, the controller 102 can transmit a command to the MUX 106 to select and forward signals that represent sensor data from the temperature sensor 130-1 and the motion sensor 130-P, where the motion sensor 130-P and the temperature sensor 130-1 are both embedded in circuitry of the of the memory device 112. The MUX 106 can transmit the signal that represents sensor data from the temperature sensor 130-1 and the motion sensor 130-P to the other device 120 via the sensor output 118.

In some examples, the computing system 100 can be, but is not limited to a mobile device, head-mounted display, and/or a vehicle (e.g., autonomous or semi-autonomous vehicle, drone, unmanned aerial vehicle (UAV), etc.). The computing system 100 can include an image sensor 115. As illustrated in FIG. 1, the image sensor 115 can be coupled to the other device 120. In some examples, the image sensor 115 can be a camera including a lens 117 and a camera timer 113. The image sensor 115 can capture one or more pictures and generate image data including the one or more captured images. The image data can comprise a number of bits representing data from the image sensor 115.

The image sensor 115 can send image data including metadata to the memory device 115. In some examples, the metadata can include an image data timestamp. The camera timer 113 can be used to create an image data timestamp. The image data timestamp can be a time at which image data was generated, for example, the time at which a picture was captured.

The other device 120 can combine the image data with orientation data from the memory device 112. In some examples, the memory device can transmit orientation data from the motion sensor 130-P to the other device 120. The orientation data can include orientation identifiers and metadata. The orientation identifiers can include alpha, beta, and gamma coordinates in degrees, for example, and the metadata can include, for example, an orientation data timestamp generated by the timer 130-2. In a number of embodiments, the motion sensor 130-P can generate orientation data and the timer 130-2 can create an orientation data timestamp corresponding to the generated orientation data.

Generating the orientation data using motion sensor 130-P embedded in the memory device 112 can increase processing performance. For example, the motion sensor 130-P embedded in the memory device 112 can enable real-time and/or decreased processing time of orientation data. A motion sensor 130-P embedded in a memory device 112 can provide an orientation of an image sensor 115 to a mapping application and/or to a 360-degree photo application in less time than a motion sensor outside external to the memory device 112, for example.

The image data can be paired with the orientation data at the other device 120 by matching at least a portion of metadata of the image data with at least a portion of metadata of the orientation data. For example, first image data including a first image timestamp at a first time can be paired with first motion sensor data including a first motion sensor timestamp at the first time. Once, the first image data and the first motion sensor data are paired, the other device 115 can modify and/or create a sequence of data where the first image data is followed by the first orientation data, as illustrated in FIG. 3.

In some examples, the other device 120 can use image data and orientation data to perform operations. Operations can include, but are not limited to correcting images, stabilizing images, creating stable panoramas, generating three-dimensional (3D) images, generating real-time maps, correcting real-time maps, and determining an orientation of the memory device 112. In some examples, an orientation of the image sensor 115 can be calculated based on the determined orientation of the memory device 112. For example, a constant bias between an orientation of the image sensor 115 and the orientation of the memory device 112 may exist and can be accounted for when calculating the orientation of the image sensor 115 based on the determined orientation of the memory device 112.

The computing system 100 can transmit the sequence of data. For example, the computing system 100 can be a mobile device including a processing resource coupled to a modulator-demodulator (modem), not illustrated. The modem can be configured to transmit the sequence of data to another computing system, for example.

In a number of embodiments, the computing system 100 can further include a wearable display. The wearable display can be, but is not limited to, a head-mounted display. The image data and/or the orientation data can be displayed on the wearable display.

The computing system 100 can include an advanced driver-assistance system (ADAS). The ADAS can be coupled to a processing resource, for example the other device 120, on the computing system 100. The ADAS can receive the data sequence and perform an operation on a vehicle in response to receiving the data sequence. For example, the ADAS can determine the vehicle is approaching a stop sign from the image data and/or the orientation data and in response apply a brake of the vehicle.

FIG. 2 is a functional block diagram in the form of a computing system 200 including memory device sensors 230 in accordance with a number of embodiments of the present disclosure. The computing system 200 can include memory device 212 and be analogous to the memory device 112 of FIG. 1. The memory device 212 can include memory array 204-1 and memory array 204-M which may be collectively referred to herein as the memory array 204 and be analogous to the memory array 104 of FIG. 1. In some examples, the memory device 212 can be a processor in memory (PIM).

The memory device 212 can include controller 202 which can be analogous to controller 102 of FIG. 1. The controller 202 can be coupled to registers 224-1, 224-2, 224-3, and 224-N and be collectively referred to herein as registers 224. The registers 224 can each be coupled to one or more sensors embedded in circuitry of the memory device 212. For example, the register 224-1 can be coupled to a temperature sensor 230-1, the register 224-2 can be coupled to a motion sensor 230-P, the register 224-3 and 224-N can be coupled to a timer 230-2 via an oscillator 230-3 and/or a counter 230-4, which may be collectively referred to as the sensor or the sensors 230. Although specific types of sensors are mentioned herein, embodiments are not so limited and other sensors can be used (e.g., a pressure sensor and/or a random number generator).

The memory device 212 can be coupled to a device 220 via a bus 205. The bus 205 can include a clock line (CLK) 208, a command line 210 to transmit commands, an address line 214 to determine where commands should be sent, and a data input/output (data I/O) 216. The other device 220 can be a CPU, a graphics processing unit (GPU), an application specific integrated circuit (ASIC), an edge computing device, etc. The other device 220 can be included as part of a host (not illustrated as to not obscure examples of the disclosure).

The bus 205 can be coupled to an input/output logic (10 logic) 219. The IO logic 219 can be a communication between the memory device 212 and the other device 220. The I/O logic 219 can include hardware to perform input and output operations for the memory device 212. The I/O logic 219 can receive information from the imbedded sensors 230 and transmit them to the other device 220 via the bus 205.

FIG. 2 illustrates an example of a device 220 and memory device 212 coupled to the other device 220. The memory device 212 includes a plurality of sensors 230 embedded in the memory device 212, and a plurality of registers 224 each respectively coupled to one of the plurality of sensors 230, the controller 202 (e.g., a command decode) to transmit commands to read one or more of the plurality of registers, and a data output (Data/IO) 216 coupled to the plurality of registers 224 (e.g., via the IO logic 219) to transmit the sensor data from the plurality of registers 224 to the other device 220.

The signal that represents sensor data transmitted from the sensors 230 to respective registers 224 can be sensor data of an operation of the sensor 230. For example, the temperature sensor 230-1 can generate a temperature value and transmit the temperature value to the register 224-1, the embedded timer 230-2 can include an oscillator 230-3 and/or a counter 230-4 which can transmit a signal representing sensor data to register 224-3 and/or 224-N, the embedded motion sensor 230-P can transmit a signal that represents motion sensor data to the register 224-2.

The embedded timer can include the oscillator 230-3 which can produce a periodic signal to transmit to the register 224-3 and/or to the counter 230-4. The counter 230-4 can (independently or concurrently with the oscillator 230-3) transmit a quantity of incidences of data collected by one or more of the sensors 230. Said differently, the oscillator 230-3 can work with the counter 230-4 to periodically generate a signal which can report a quantity of signals generated from any of the sensors 230. In contrast, the oscillator 230-3 and the counter 230-4 can operate independently to transmit respective signals that represent sensor data to respective registers.

In some embodiments, the controller 202 can configure the sensors 230 to generate signals that represent sensor data based on parameters. For example, the controller 202 can configure the sensors 230 to generate signals that represent sensor data to the respective registers 224 when the other device 220 is located in a particular environment. The controller 202 can generate a register read command 222 to read the sensor data stored in the respective registers and the I/O logic 219 can transmit the sensor data from the registers 224 to the other device 220.

The environment can be a location of the other device 220 (e.g., a location of the host coupled to the other device). The controller 202 can receive an indication from the other device 220 related to the environment, and the controller 202 can configure the sensors 230 to generate signals that represent sensor data about the environment. For example, the controller 202 can receive an indication that the other device 220 (e.g., a host coupled to the other device 220) is located in an environment. The controller 202 can configure the temperature sensor 230-1 to generate a temperature value (e.g., an encoded 8-bit binary string) and transmit the temperature value to the register 224-1. Responsive to a register read command 222 transmitted from the controller 202, the I/O logic 219 can transmit the signal that represents sensor data from the register 224-1 including the temperature value to the other device 220. Said differently, the I/O logic 219 can transmit the values related to the respective operations of the plurality of sensors 230 to the other device 220. Using these methods, the temperature value generated by the embedded temperature sensor 230-1 can be accessible to the other device 220 and/or the host/user.

In some embodiments, the embedded timer 230-2 (using an embedded oscillator 203-3 and/or an embedded counter 230-4) can produce a timer output with a fixed period such as 1 μs. In other embodiments, the timer output can be a flag, where the controller 202 is configured to generate a register read command 222 when a quantity of seconds have elapsed. The controller 202 can program the memory device 212 to generate sensor outputs to the respective registers 224 based on the quantity of seconds that have elapsed.

As mentioned, the motion sensor 230-P can be embedded in the circuitry of the memory device 212 and can detect a change in motion within an environment. For example, the environment can be a location of the other device 220 (e.g., a location of the host coupled to the other device). The controller 202 can receive an indication from the other device 220 related to the environment and the controller 202 can configure the sensors 230 to generate signals that represent sensor data about the environment. For example, the controller 202 can receive an indication that the other device 220 (e.g., a host coupled to the other device 220) is located in an environment. The controller 202 can configure the motion sensor 230-P to generate a flag if motion is detected in the environment. Responsive to a register read command 222 transmitted from the controller 202, the I/O logic 219 can transmit the sensor data from the register 224-2 including the motion sensor flag to the other device 220.

In some embodiments, multiple embedded sensors 230 can be used in combination to provide information to the host/user via the other device 220. For example, the other device 220 can be coupled to an IoT device (e.g., a host) and the IoT device can initiate an operation responsive to transmission of the signals that represent sensor data (e.g., from one or more of the sensors 230) from the plurality of registers 224 to the other device 220. The IoT device can include the other device 220 and can make decisions based on the received sensor data. For example, the IoT device may be a mobile phone, and the other device 220 coupled to the mobile phone may receive a temperature value from the temperature sensor 230-1, and the motion sensor 230-P embedded in the memory device 212 of the mobile phone. Based on the receipt of the temperature value and the motion sensor value, the other device 220 may initiate the mobile phone to change an operation (e.g., switch from on to off). Using these methods, hosts/users can gain access to sensor data generated by the embedded sensors and avoid the need for external sensor installations.

In some examples, the computing system 200 can be, but is not limited to a mobile device, head-mounted display, and/or a vehicle (e.g., autonomous or semi-autonomous vehicle, drone, unmanned aerial vehicle (UAV), etc.). The computing system 200 can include an image sensor 215. As illustrated in FIG. 2, the image sensor 215 can be coupled to the memory device 212. In some examples, the image sensor 215 can be a camera including a lens 217 and a camera timer 213. The image sensor 215 can capture one or more pictures and generate a signal representing image data including the one or more captured images.

The image sensor 215 can send a signal representing image data including metadata to the memory device 215. The signal can include an image data timestamp. The camera timer 213 can be used to create an image data timestamp. The image data timestamp can be a time at which image data was generated, for example, the time at which a picture was captured.

The memory device 212 can be configured as a PIM and/or the controller 202 and the I/O logic 207 can be configured to perform processing operations including combining the orientation data with the image data from the image sensor 215. The memory device 212 can collect orientation data from the motion sensor 230-P. The orientation data can include orientation identifiers and metadata. The orientation identifiers can include alpha, beta, and gamma coordinates in degrees, for example, and the metadata can include, for example, an orientation data timestamp generated by the timer 230-2. In a number of embodiments, the motion sensor 230-P can generate orientation data and the timer 230-2 can create an orientation data timestamp corresponding to the generated orientation data.

Generating the orientation data using motion sensor 230-P embedded in the memory device 212 and processing the orientation data in memory using PIM can increase processing performance. For example, the motion sensor 230-P embedded in the memory device 212 and PIM can enable real-time and/or decreased processing time of orientation data.

The image data can be paired with the orientation data at the memory device 212 by matching at least a portion of metadata of the image data with at least a portion of metadata of the orientation data. For example, first image data including a first image timestamp at a first time can be paired with first motion sensor data including a first motion sensor timestamp at the first time. Once the first image data and the first motion sensor data are paired, the memory device 212 can modify and/or create a sequence of data where the first image data is followed by the first orientation data, as illustrated in FIG. 3.

In some examples, the memory device 212, configured as PIM, can use image data and orientation data to perform operations. Operations can include, but are not limited to correcting images, stabilizing images, creating stable panoramas, generating three-dimensional (3D) images, generating real-time maps, correcting real-time maps, and determining an orientation of the memory device 212. In some examples, an orientation of the image sensor 215 can be calculated based on the determined orientation of the memory device 212. For example, a constant bias between an orientation of the image sensor 215 and the orientation of the memory device 212 may exist and can be accounted for when calculating the orientation of the image sensor 215 based on the determined orientation of the memory device 212.

FIG. 3 is a block diagram of a sequence of image data and orientation data in accordance with a number of embodiments of the present disclosure. The sequence of image data and orientation data can be generated by the other device and the memory device, as previously described in connection with FIG. 1 and FIG. 2, respectively.

The sequence of image data and orientation data can include first image data 331-1 followed by corresponding first orientation data 332-1. The sequence of image data can continue with second image data 331-2 followed by corresponding second orientation data 332-2 and third image data 331-X followed by third orientation data 332-Y.

The sequence of image data and orientation data can be used to perform operations including, but not limited to correcting images, stabilizing images, creating stable panoramas, generating three-dimensional (3D) images, generating real-time maps, correcting real-time maps, determining an orientation of the memory device, and/or an orientation of the image sensor based on the determined orientation of the memory device.

In some examples, the sequence of image data and orientation data can be stored for performing future operations. For example, the sequence of image data and orientation data can be stored in the memory device, in the other device, and/or in other memory external to the memory device.

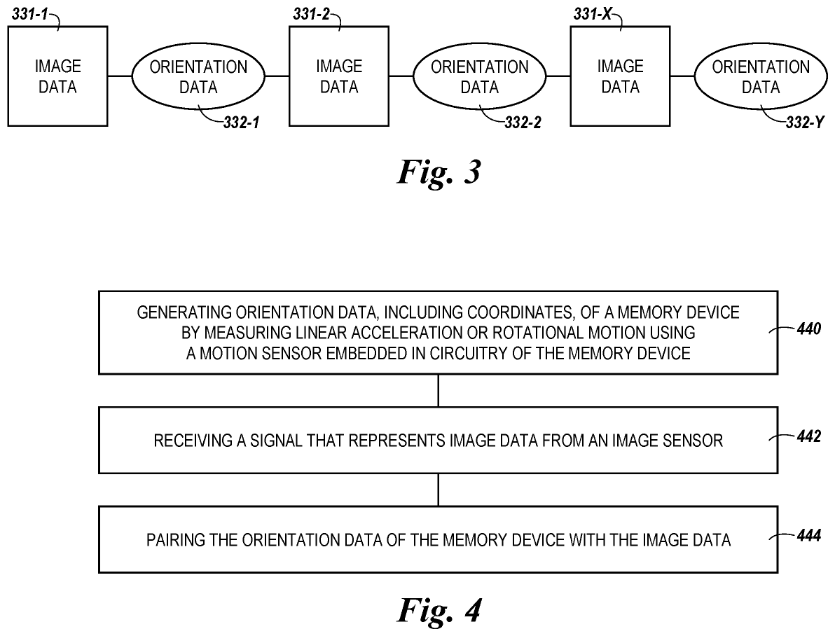

FIG. 4 is a flow diagram representing an example method for memory device sensors in accordance with a number of embodiments of the present disclosure. At block 440, the method includes generating a signal representing orientation data of a memory device using a motion sensor embedded in the memory device. The orientation data can include orientation identifiers including alpha, beta, and gamma coordinates. The orientation data can also include metadata including an orientation data timestamp. The orientation data timestamp can be generated by a memory device timer. For example, the motion sensor can generate orientation data and the memory device timer can create an orientation data timestamp corresponding to the generated orientation data.

At block 442, the method includes receiving a signal representing image data from an image sensor. The image sensor can be coupled to a memory device and/or another device and the memory device and/or the other device can receive the signal representing the image data from the image sensor.

In some examples, the image sensor can be a camera including a lens and a camera timer. The image sensor can capture one or more pictures and generate image data including the one or more captured images. The image data can also include metadata. In some examples, a timestamp, generated by the camera timer, can be included in the metadata. The timestamp can be generated in response to capturing a picture, for example.

At block 444, the method includes pairing the orientation data of the memory device with the image data. The memory device and/or the other device pair the orientation data with the image data by matching an image timestamp at a first time with a motion sensor timestamp at the first time.

Once paired, the memory device and/or the other device can modify and/or create a sequence of data where the image data with a timestamp at the first time is followed by the motion sensor data with a timestamp at the first time. The sequence of data can be used to perform operations including correcting images, stabilizing images, creating stable panoramas, generating three-dimensional (3D) images, generating real-time maps, correcting real-time maps, determining an orientation of the memory device, and/or an orientation of the image sensor based on the determined orientation of the memory device.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
generating orientation data, including coordinates, of a memory device by measuring linear acceleration or rotational motion using a motion sensor embedded in circuitry of the memory device;
receiving a signal that represents image data from an image sensor; and
pairing the orientation data of the memory device with the image data.

2. The method of claim 1, wherein pairing the orientation data of the memory device with the image data comprises:
matching at least a portion of metadata of the orientation data with at least a portion of metadata of the image data.

3. The method of claim 2, wherein the portion of metadata of the orientation data and the portion of metadata of the image data each include a timestamp.

4. The method of claim 1, wherein the orientation data generated at a first time is paired with the image data generated at the first time.

5. The method of claim 1, further comprising:
performing an operation using the image data and the orientation data.

6. The method of claim 5, wherein the operation includes correcting an image.

7. The method of claim 6, where the image is a three-dimensional (3D) image.

8. The method of claim 5, wherein the operation includes determining an orientation of the image sensor.

9. The method of claim 5, wherein the operation includes image stabilization.

10. An apparatus, comprising:
a memory array;
a motion sensor coupled to the memory array, wherein the motion sensor is configured to:
generate a signal that represents orientation data of the apparatus; and
a processing device coupled to the motion sensor and the memory array, wherein the processing device is configured to:
receive the signal that represents the orientation data from the motion sensor;
receive a signal that represents image data from an image sensor; and
pair the image data with the orientation data.

11. The apparatus of claim 10, wherein the motion sensor is a microelectromechanical system (MEMS) gyroscope.

12. The apparatus of claim 10, wherein the orientation data includes orientation identifiers.

13. The apparatus of claim 10, wherein the orientation data includes a time at which the orientation data was generated.

14. The apparatus of claim 10, wherein the image data includes a time at which the image data was generated.

15. The apparatus of claim 13, further comprising:
a timer to generate the time at which the orientation data was generated.

16. A system, comprising:
an image sensor configured to:
generate a signal that represents image data;
a memory array coupled to the image sensor;
a motion sensor coupled to the memory array, wherein the motion sensor is configured to:
generate a signal that represents orientation data; and
a processing device coupled to the image sensor and the memory array, wherein the processing device is configured to:
receive the signal that represents the orientation data;
receive the signal that represents the image data;
pair the image data with the orientation data; and
generate a data sequence of the image data and the orientation data.

17. The system of claim 16, wherein the memory array is dynamic random access memory (DRAM).

18. The system of claim 16, further comprising a modulator-demodulator (modem) coupled to the processing device, wherein the modem is configured to transmit the data sequence of the image data and the orientation data.

19. The system of claim 16, further comprising a wearable display coupled to the processing device, wherein the wearable display is configured to display the image data or the orientation data.

20. The system of claim 16, further comprising an advanced driver-assistance system (ADAS) coupled to the processing device, wherein the ADAS is configured to perform an operation on a vehicle in response to receiving the data sequence of the image data and the orientation data.
